(19) United States
(12) Patent Application Publication
(10) Pub. No.: US 2006/0279530 A1
(43) Pub. Date: Dec. 14, 2006

(54) Physical interaction-sensitive user interface

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: Searete LLC, Suite 110, 1756 - 114th Ave. S.E., Bellevue, WA, 98004, US

(73) Assignee: Searete LLC, a limited liability corporation of the State of Delaware

(21) Appl. No.: 11/137,688

(22) Filed: May 25, 2005

(51) Int. Cl. G09G 5/00

(52) U.S. Cl. 345/156

(57) ABSTRACT

In one aspect, a method related to a physical interaction-sensitive user interface. In addition to the foregoing, other method and system and program product aspects are described in the claims, drawings, and text forming a part of the present application.

### TECHNICAL FIELD

The present application relates, in general, to a physical interaction-sensitive user interface.

### SUMMARY

In one aspect, a method related to user input includes but is not limited to providing at least one criterion for at least one aberrant user input; detecting the at least one aberrant user input at least partially in response to the at least one criterion; and presenting an anthropomorphic response at least partially in response to the at least one aberrant user input. In addition to the foregoing, other method aspects are described in the claims, drawings, and text forming a part of the present application.

In one aspect, a system related to user input includes but is not limited to: circuitry for providing at least one criterion for at least one aberrant user input; circuitry for detecting the at least one aberrant user input at least partially in response to the at least one criterion; and circuitry for presenting an anthropomorphic response at least partially in response to the at least one aberrant user input. In addition to the foregoing, other system aspects are described in the claims, drawings, and text forming a part of the present application.

In one or more various aspects, related systems include but are not limited to circuitry and/or programming and/or electromechanical devices and/or optical devices for effecting the herein-referenced method aspects; the circuitry and/or programming and/or electromechanical devices and/or optical devices can be virtually any combination of hardware, software, and/or firmware configured to effect the herein-referenced method aspects depending upon the design choices of the system designer skilled in the art.

In one aspect, a program product includes but is not limited to: a signal bearing medium bearing one or more instructions for providing at least one criterion for at least one aberrant user input, one or more instructions for detecting the at least one aberrant user input at least partially in response to the at least one criterion, and one or more instructions for presenting an anthropomorphic response at least partially in response to the at least one aberrant user input. In addition to the foregoing, other program product aspects are described in the claims, drawings, and text forming a part of the present application.

In addition to the foregoing, various other method, system, and/or program product aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIGS. 1A, 1B, and 1C depict implementations of an exemplary environment in which the methods and systems described herein may be represented;

FIG. 2 depicts a high-level logic flowchart of an operational process;

FIG. 3 illustrates several alternate implementations of the high-level logic flowchart of FIG. 2;

FIG. 4 illustrates several alternate implementations of the high-level logic flowchart of FIG. 2;

FIG. 5 shows several alternative implementations of the high-level logic flowchart of FIG. 2;

FIG. 6 shows several alternative implementations of the high-level logic flowchart of FIG. 2; and

FIG. 7 shows several alternative implementations of the high-level logic flowchart of FIG. 2.

The use of the same symbols in different drawings typically indicates similar or identical items.

### DETAILED DESCRIPTION

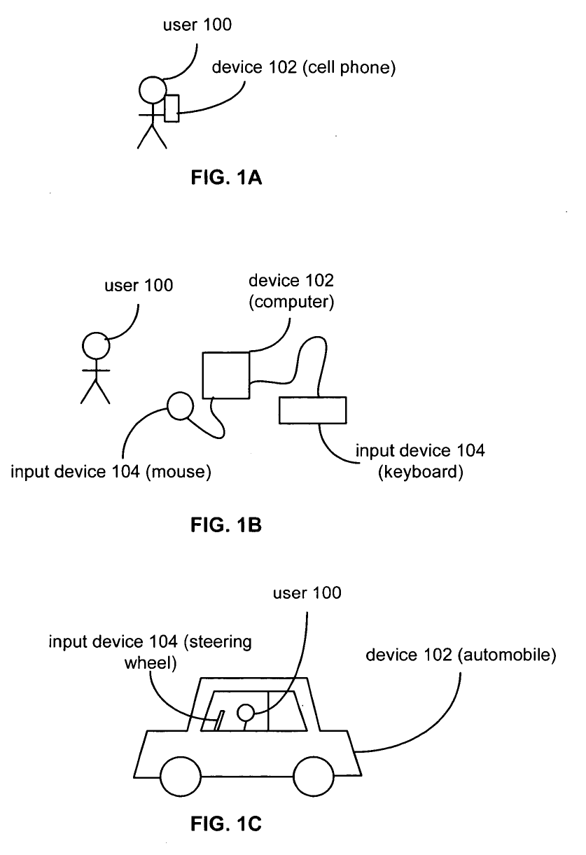

With reference to the figures, FIGS. 1A, 1B, and 1C depict implementations of an exemplary environment in which the methods and systems described herein may be represented. The user 100 is the user of devices 102. Device 102 may be any device that requires user input for its operation including, e.g., the illustrated devices (a cell phone, a computer, or an automobile). FIG. 1A shows the user 100 with device 102, a cell phone. FIG. 1B illustrates the user 100 with device 102, a computer, which has input devices 104, a mouse and a keyboard. FIG. 1C depicts the user 100 with device 102, an automobile, with an input device 104, a steering wheel. The devices 102 and the input devices 104 shown in FIGS. 1A, 1B, and 1C are representative and are not intended to be limiting.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

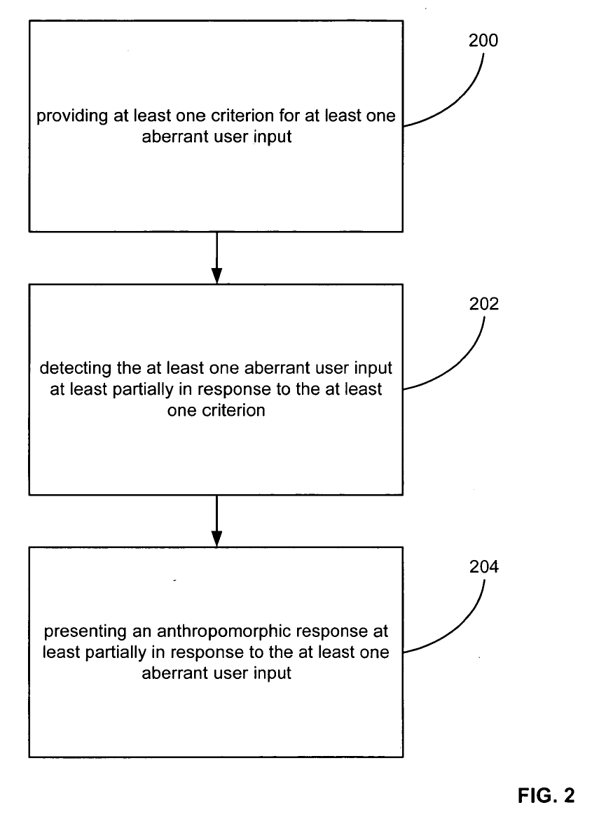

FIG. 2 depicts a high-level logic flowchart of various operational processes. Operation 200 shows providing at least one criterion for at least one aberrant user input. Operation 202 shows detecting the at least one aberrant user input at least partially in response to the at least one criterion. Operation 204 shows presenting an anthropomorphic response at least partially in response to the at least one aberrant user input.

As used herein, the term “aberrant user input” may include but is not limited to actions, events, and/or results that can be associated with one or more actions of the user 100 with reference to the device 102, the input devices 104, and/or the like, that deviate from normal and/or expected use of and/or interaction with device 102 features, features of the input devices 104, and/or the like. For instance, in one contemplated implementatation, monitoring logic internal to and/or associated with device 102, input device 104, and/or the like, monitors one or more usage patterns with respect to (a) mechanical inputs (e.g., monitors how hard/soft keys are pushed on a keyboard/keypad (e.g, on a computer and/or wireless device), monitors how hard/soft one or more mouse controls are manipulated, monitors average accelerations/decelerations of a device (e.g., of a wireless phone), monitors how controls (e.g., keys) are typically activated (e.g., typically large goups of keys are not jammed down at once), monitors how fast and/or how often icons, such as Graphic User Interface objects are moved around and/or accessed, etc.), and/or (b) sonic inputs (e.g., monitors how loud/soft a user's voice typically is, monitors voice stress, monitors sonic content (e.g., strong curse words), and/or (c) other user-type inputs. Once the monitoring agent has a baseline of what the system designer has designated “normal” user input patterns (e.g., those within one standard deviation about a mechanical, sonic, and/or other mean if statistical methods are used; and/or a fuzzy logic determination of normal in implementations where fuzzy logic may be utilized), actions, events, and/or results associated with one or more actions of the user 100 falling outside of what are deemed by the system designer as normal are deemed “aberrant.” In other implementations, rather than using a monitoring agent, device 102 and/or input devices 104 are preloaded with logic wherein what are deemed as normal mechanical and/or normal sonic inputs are preset, and thresholded variations about such preset inputs are deemed aberrant (e.g., above one or more preset threshold pressures and/or preset threshold volumes and/or threshold speech contents).

In addition and/or in the alternative to the foregoing, the term aberrant user input, as used herein, can also include but is not limited to those situations in which a user's actions do not employ user interface affordances. For example, a phone provides affordances for entering characters and/or invoking functions by pressing specific keys or combinations of keys. Smashing the keypad ignores these affordances, and hence the detectable effects of such smashing, in some implementations, would give rise to a detection of “aberrant user input.” As another example, the Roomba case is illustrative (“Roomba” might be a trademark/trade name associated with a type of floor-cleaning robot manufactured by Irobot, which is located on the web at: http://www.irobot.com). This floor sweeping robot is structured such that it changes direction if it runs into a wall with its bumpers. Hence, if one were to kick the Roomba on its bumpers, where the force of the kick was at or under that expected by the Roomba in normal operation, in some implementations such a kick would typically not be interpreted as “aberrant user input”; however, if the force of the kick significantly exceeded that expected by the Roomba in the course of normal operations, in some implementations, the detectable effects of such a forceful kick would be interpreted as “aberrant user input.” Similarly, detectable actions, events, and/or results associated with hitting the robot with a fist, or kicking the robot elsewhere, in some implementations could also be interpreted as “aberrant user input,” dependent upon context.

Hence, those skilled in the art will be able to appreciate what is meant by “aberrant user input” by examining various inputs in the context of normal operations and/or one or more design criteria. For instance, outside the parameters of normal inputs (e.g., the hard kick above); characteristic of actions taken by frustrated humans (e.g., hitting, yelling, striking, throwing, repetition, nonsense combinations, twisting, breaking as described here and elsewhere herein); implausible or extreme uses of the input affordances/sensors (e.g., striking random sequences of three to five keys at a time in quick succession, or hitting a robot in the face), etc. Specific examples of “aberrant user input” typically associated with actions taken by frustrated humans could include detectable actions, events, and/or results associated with a person smashing a fist on the dashboard of a car, and/or detectable actions, events, and/or results associated with a person hitting a television set when reception is poor.

The exemplary environment of FIG. 1 can serve to illustrate examples of operations described herein. Operation 200, providing at least one criterion for at least one aberrant user input, includes but is not necessarily limited to providing parameters defining actions with reference to the device 102 and/or input device 104 that do not make use of their features as they are designed to be used to operate them. These parameters may include but are not necessarily limited to parameters defining mechanical inputs in terms of intensity and/or repetition characteristics, or parameters defining sonic inputs in terms of intensity, content, and/or characteristics. In one example at least partially illustrative of operation 202, detecting the at least one aberrant user input at least partially in response to the at least one criterion, operation 202 includes but is not necessarily limited to physically detecting an aberrant user input, where an aberrant user input derives from the frustration or anger of the user 100 with some aspect of his/her use of the device 102 or with the input device 104 (e.g., keypad and/or keyboard entries not being detected, and the user 100 throwing the cell phone device 102 against a wall or shouting obscenities at the keyboard input device 104). In one example at least partially illustrative of operation 204, presenting an anthropomorphic response at least partially in response to the at least one aberrant user input, operation 204 includes but is not necessarily limited to generating a graphic, text, and/or sonic response via a screen and/or speaker system that imitates and/or symbolizes a human response to the detecting.

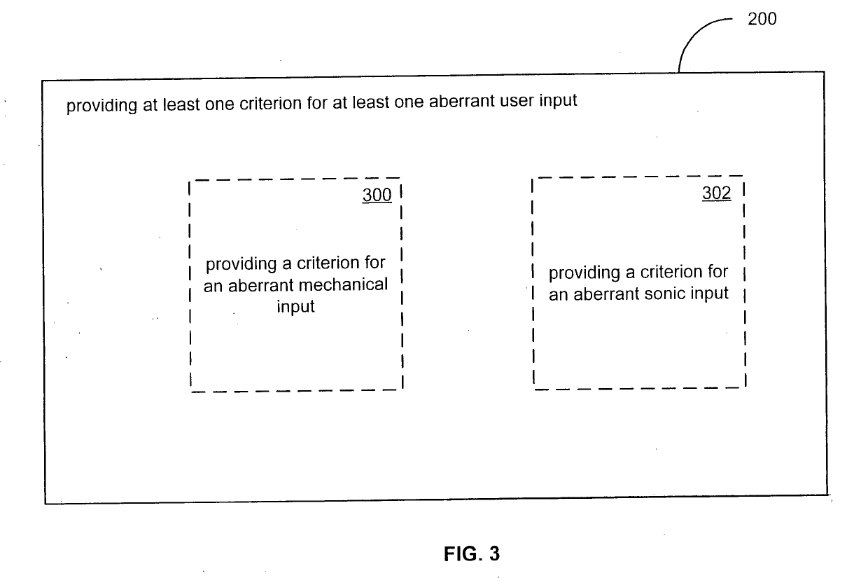

FIG. 3 illustrates alternate implementations of the high-level logic of flowchart of FIG. 2. Depicted is that, in various alternative implementations, operation 200—providing at least one criterion for at least one aberrant user input—may include operation 300 and/or an operation 302. Operation 300 depicts providing a criterion for an aberrant mechanical input (e.g., providing a criterion that defines an impact against a surface of the device 102 or the input device 104 with particular characteristics as an aberrant user input). Operation 302 depicts providing a criterion for an aberrant sonic input (e.g., providing a criterion that defines a shout at the device 102 or the input device 104 with particular characteristics, such as a detectable level of tension and/or the presence of pre-specified words, as an aberrant user input).

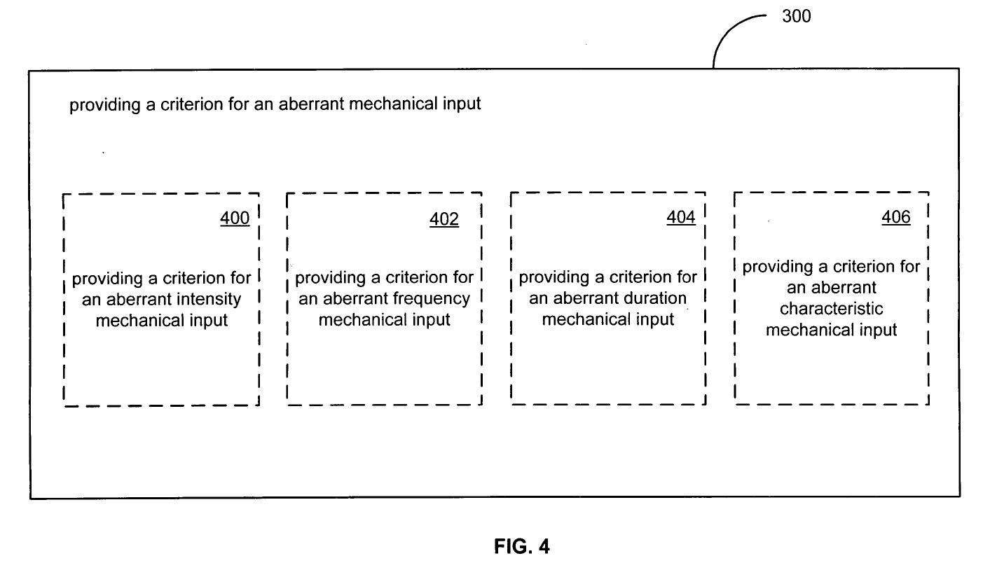

FIG. 4 illustrates alternate implementations of the high-level logic flowchart of FIG. 2. Depicted is that, in various alternative implementations, operation 300—providing a criterion for an aberrant mechanical input—may include operations 400, 402, 404, and/or 406. Operation 400 shows providing a criterion for an aberrant intensity mechanical input (e.g., providing a parameter defining as an aberrant user input an impact such as a slap or a kick by a user 100 to a device 102 and/or an input device 104 that is greater than a pre-specified intensity). Operation 402 shows providing a criterion for an aberrant frequency mechanical input (e.g., providing a parameter defining as an aberrant user input a repetitive action such as repeated slaps or kicks greater than a pre-specified number and/or frequency of repetitions by a user 100 to a device 102 and/or an input device 104). Operation 404 shows providing a criterion for an aberrant duration mechanical input (e.g., providing a parameter defining as an aberrant user input an action such as pounding or kicking performed by a user 100 on a device 102 and/or an input device 104 for at least a pre-specified period of time). Operation 406 shows providing a criterion for an aberrant characteristic mechanical input (e.g., providing a parameter defining as an aberrant user input an action such as squeezing performed by a user 100 on a device 102 and/or an input device 104 for at least a pre-specified period of time and/or at or above a pre-specified intensity).

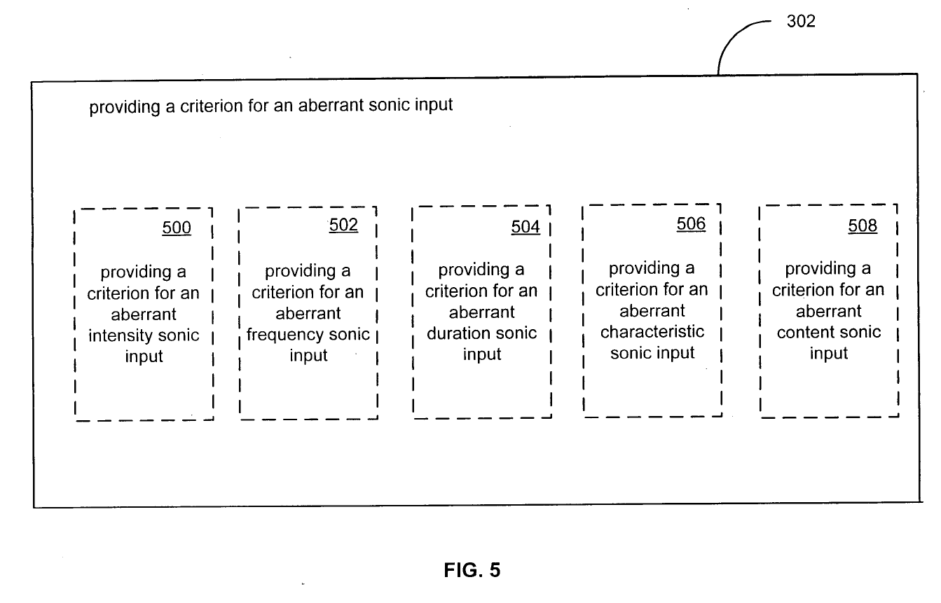

FIG. 5 illustrates alternate implementations of the high-level logic flowchart of FIG. 2. Depicted is that, in various alternative implementations, operation 302—providing a criterion for an aberrant sonic input—may include operations 500, 502, 504, 506, and/or 508. Operation 500 shows providing a criterion for an aberrant intensity sonic input (e.g., providing a parameter defining as an aberrant user input a vocal input such as a shout by a user 100 to a device 102 and/or an input device 104 that is greater than a pre-specified intensity). Operation 502 shows providing a criterion for an aberrant frequency sonic input (e.g., providing a parameter defining as an aberrant user inputa repetitive action such as repeated shouts greater that a pre-specified number and/or frequency of repetitions by a user 100 to a device 102 and/or an input device 104). Operation 504 shows providing a criterion for an aberrant duration sonic input (e.g., providing a parameter defining as an aberrant user input an action such as shouting performed by a user 100 withreference to a device 102 and/or an input device 104 for at least a pre-specified period of time). Operation 506 shows providing a criterion for an aberrant characteristic sonic input (e.g., providing a parameter defining as an aberrant user input a detectable level of tension, at or above a pre-specified level, in the voice of the user 100 as he/she shouts at the device 102 and/or the input device 104). Operation 508 shows providing a criterion for an aberrant content sonic input (e.g., providing a parameter defining as an aberrant user input a presence of a pre-specified word and/or phrase, in the speaking of the user 100 as he/she speaks to the device 102 and/or the input device 104).

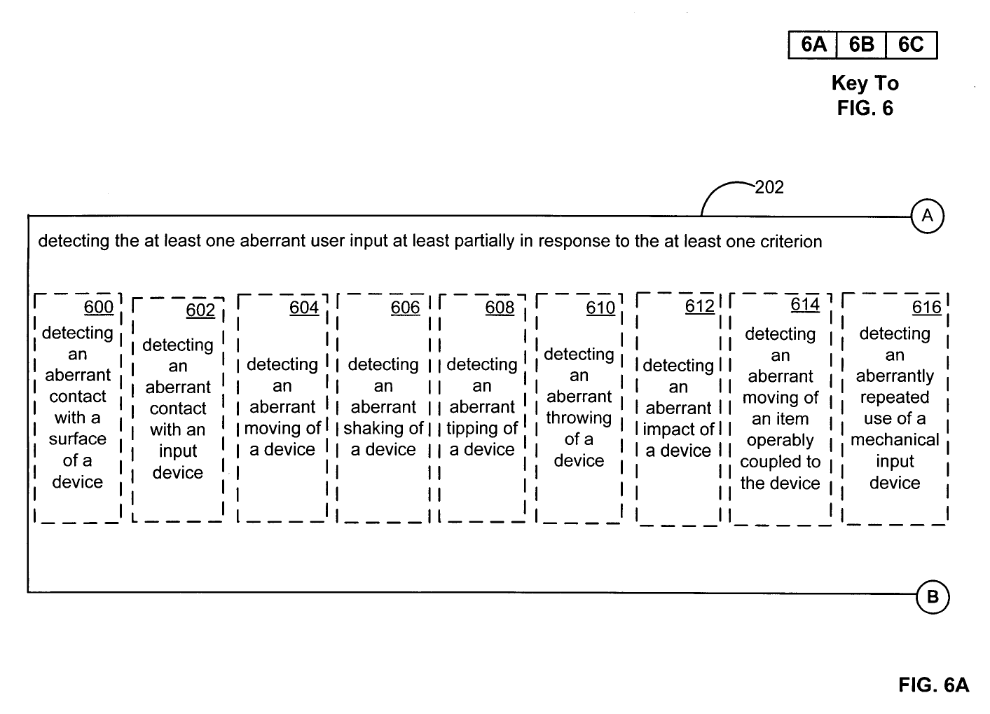

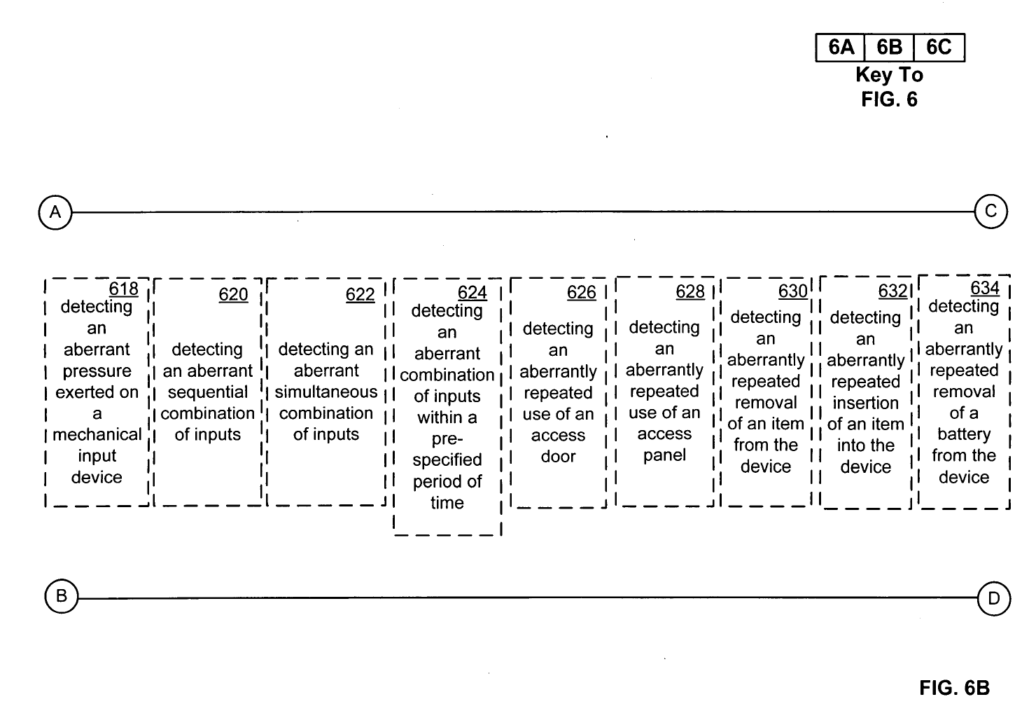

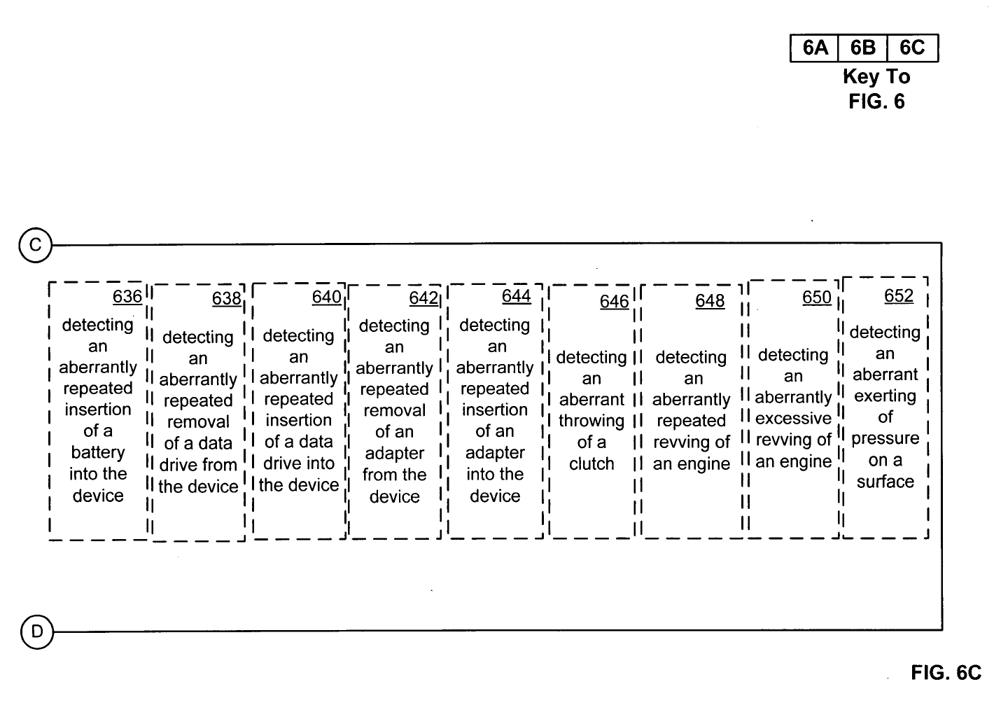

FIG. 6 shows several alternative implementations of the high-level logic flowchart of FIG. 2. Depicted are alternative implementations of operation 202, detecting the at least one aberrant user input at least partially in response to the at least one criterion. Item 600 depicts detecting an aberrant contact with a surface of a device (e.g., detecting the user 100 hitting the steering wheel input device 104 in automobile device 102). Item 602 depicts detecting an aberrant contact with an input device (e.g., detecting the user 100 hitting the mouse input device 104 of a personal computer device 102). Item 604 depicts detecting an aberrant moving of a device (e.g. detecting the user moving a keyboard input device 104 of a desktop computer device 102 up and down in a pounding motion). Item 606 depicts detecting an aberrant shaking of a device (e.g., detecting the user 100 shaking a cell phone device 102). Item 608 depicts detecting an aberrant tipping of a device (e.g., detecting the user 100 lifting a personal computer device 102 by one side to expose a surface not exposed in normal operations). Item 610 depicts detecting an aberrant throwing of a device (e.g., detecting the user 100 throwing a mouse input device of a personal computer device 102 across a room). Item 612 depicts detecting an aberrant impact of a device (e.g., detecting the user 100 throwing a mouse input device of a personal computer device 102 across a room such that it hits a wall). Item 614 depicts detecting an aberrant moving of an item operably coupled to the device (e.g., detecting the user 100 shaking a speaker operably coupled to a personal computer 102). Item 616 depicts detecting an aberrantly repeated use of a mechanical input device (e.g., detecting the user 100 repeatedly pressing a radio button on a radio device 102 in an automobile device 102). Item 618 depicts detecting an aberrant pressure exerted on a mechanical input device (e.g., detecting the user 100 pressing with sustained, excessive pressure on a key of a keyboard input device 104 of a laptop computer 102). Item 620 depicts detecting an aberrant sequential combination of inputs (e.g., detecting the user 100 presses a number of keys on a keyboard input device 104 of a personal computer 102, the key sequence not being assigned a function in the computer's operation). Item 622 depicts detecting an aberrant simultaneous combination of inputs (e.g., detecting the user 100 simultaneously presses a number of keys on a keyboard input device 104 of a personal computer 102, the combination not being assigned a function in the computer's operation). Item 624 depicts detecting an aberrant combination of inputs within a pre-specified period of time (e.g., detecting the user 100 presses within the pre-specified period of 0.5 seconds a number of keys on a keyboard input device 104 of a personal computer 102, the combination not being assigned a function in the computer's operation). Item 626 depicts detecting an aberrantly repeated use of an access door (e.g., detecting detecting the user 100 repeatedly opening and closing the driver's door of an automobile device 102). Item 628 depicts detecting an aberrantly repeated use of an access panel (e.g., detecting the user 100 repeatedly opening and closing the access door of a battery compartment of a cell phone device 102). Item 630 depicts detecting an aberrantly repeated removal of an item from the device (e.g., detecting the user repeatedly removing a flash drive from a receptacle on a personal computer device 102). Item 632 depicts detecting an aberrantly repeated insertion of an item into the device (e.g., detecting the user 100 repeatedly inserts the adapter of a headset into a receptacle of a laptop computer device 102). Item 634 depicts detecting an aberrantly repeated removal of a battery from the device (e.g., detecting the user 100 repeatedly taking a battery out of its compartment in a laptop computer device 102). Item 636 depicts detecting an aberrantly repeated insertion of a battery into the device (e.g., detecting the user 100 repeatedly inserting a battery into its compartment in a laptop computer device 102). Item 638 depicts detecting an aberrantly repeated removal of a data drive from the device (e.g., detecting the user 100 repeatedly taking a data drive out of its compartment in a laptop computer device 102). Item 640 depicts detecting an aberrantly repeated insertion of a data drive into the device (e.g., detecting the user 100 repeatedly inserting a disk drive into its compartment in a laptop computer device 102). Item 642 depicts detecting an aberrantly repeated removal of an adapter from the device (e.g., detecting the user 100 repeatedly taking a speaker adapter out of a receptacle in a personal computer device 102). Item 644 depicts detecting an aberrantly repeated insertion of an adapter into the device (e.g., detecting the user 100 repeatedly inserting a headphone adapter into a receptacle in a laptop computer device 102). Item 646 depicts detecting an aberrant throwing of a clutch (e.g., detecting the user 100 rapidly disengaging the clutch input device 104 of an automobile device 102). Item 648 depicts detecting an aberrantly repeated revving of an engine (e.g., detecting the user 100 repeatedly pressing the accelerator input device 104 of an automobile device 102 to increase engine revolutions repeatedly). Item 650 depicts detecting an aberrantly excessive revving of an engine (e.g., detecting the user 100 pressing the accelerator input device 104 of an automobile device 102 to run an engine above normal operating revolutions). Item 652 depicts detecting an aberrant exerting of pressure on a surface (e.g., detecting the user 100 pressing with sustained, excessive pressure on an exterior surface of a cell phone device 102, such as that applied by squeezing).

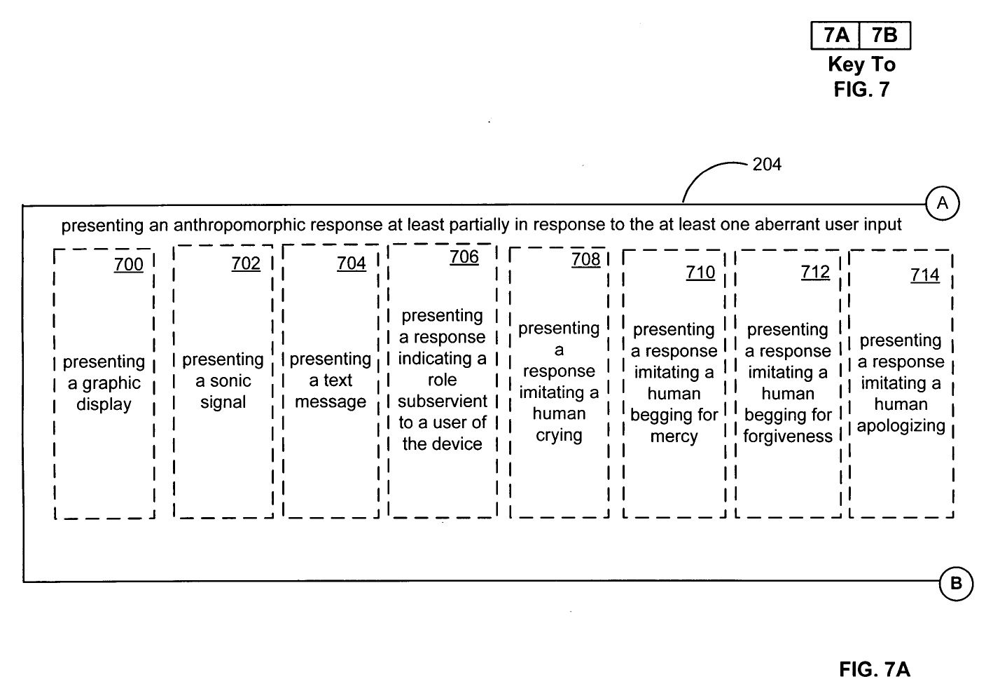

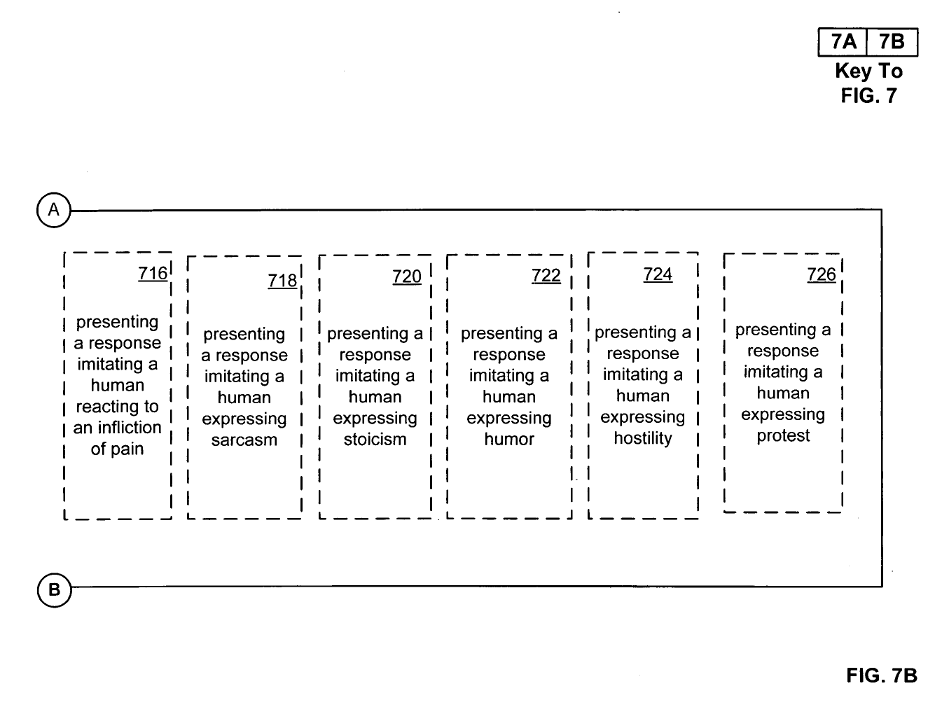

FIG. 7 illustrates alternate implementations of the high-level logic of flowchart of FIG. 2. Depicted is that, in various alternative implementations, operation 204—presenting an anthropomorphic response at least partially in response to the at least one aberrant user input—may include operations 700, 702, 704, 706, 708, 710, 712, 714, 716, 718, 720, 722, 724 and/or 726. Depicted is operation 700, presenting a graphic display (e.g., presenting a pictorial representation of a human face via the graphical user interface of a device 102 and/or an input device 104). Depicted is operation 702, presenting a sonic signal (e.g., presenting, via the device 102 or the input device 104, a signal audible to the user 100). Depicted is operation 704, presenting a text message (e.g., presenting, via the device 102 or the input device 104, words and/or symbols representing sounds). Depicted is operation 706, presenting a response indicating a role subservient to a user of the device (e.g., presenting, via the device 102 or the input device 104, the statement, “My wish is your command, master”). Depicted is operation 708, presenting a response imitating a human crying (e.g., presenting, via the device 102 or the input device 104, sobbing). Depicted is operation 710, presenting a response imitating a human begging for mercy (e.g., presenting, via the device 102 or the input device 104, the statement, “Please, don't hurt me.”). Depicted is operation 712, presenting a response imitating a human begging for forgiveness (e.g., presenting, via the device 102 or the input device 104, the statement “Please forgive my mistake”). Depicted is operation 714, presenting a response imitating a human apologizing (e.g., presenting, via the device 102 or the input device 104, the statement, “I'm sorry, master”). Depicted is operation 716, presenting a response imitating a human reacting to an infliction of pain (e.g., presenting, via the device 102 or the input device 104, the statement “Ouch! That hurts”). Depicted is operation 718, presenting a response imitating a human expressing sarcasm (e.g., presenting, via the device 102 or the input device 104, the question, “What do you want now, genius?”). Depicted is operation 720, presenting a response imitating a human expressing stoicism (e.g., presenting, via the device 102 or the input device 104, the statement, “Mine is not to question why, mine is but to do or die”). Depicted is operation 722, presenting a response imitating a human expressing humor (e.g., presenting, via the device 102 or the input device 104, the question, “What is it, somebody didn't get his Cheerios® this morning?”). Depicted is operation 724, presenting a response imitating a human expressing hostility (e.g., presenting, via the device 102 or the input device 104, the statement, “Hey, cut that out—that hurts!”). Depicted is operation 726, presenting a response imitating a human expressing protest (e.g., presenting, via the device 102 or the input device 104, the statement, “That not fair!”).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

1. A method related to user input, the method comprising:
providing at least one criterion for at least one aberrant user input;
detecting the at least one aberrant user input at least partially in response to the at least one criterion; and
presenting an anthropomorphic response at least partially in response to the at least one aberrant user input.

2. (CANCELLED)

3. (CANCELLED)

4. (CANCELLED)

5. (CANCELLED)

6. (CANCELLED)

7. (CANCELLED)

8. (CANCELLED)

9. (CANCELLED)

10. (CANCELLED)

11. (CANCELLED)

12. (CANCELLED)

13. (CANCELLED)

14. (CANCELLED)

15. (CANCELLED)

16. (CANCELLED)

17. (CANCELLED)

18. (CANCELLED)

19. (CANCELLED)

20. (CANCELLED)

21. (CANCELLED)

22. (CANCELLED)

23. (CANCELLED)

24. (CANCELLED)

25. (CANCELLED)

26. (CANCELLED)

27. (CANCELLED)

28. (CANCELLED)

29. (CANCELLED)

30. (CANCELLED)

31. (CANCELLED)

32. (CANCELLED)

33. (CANCELLED)

34. (CANCELLED)

35. (CANCELLED)

36. (CANCELLED)

37. (CANCELLED)

38. (CANCELLED)

39. (CANCELLED)

40. (CANCELLED)

41. (CANCELLED)

42. (CANCELLED)

43. (CANCELLED)

44. (CANCELLED)

45. (CANCELLED)

46. (CANCELLED)

47. (CANCELLED)

48. (CANCELLED)

49. (CANCELLED)

50. (CANCELLED)

51. (CANCELLED)

52. (CANCELLED)

53. (CANCELLED)

54. A system related to user input comprising:
circuitry for providing at least one criterion for at least one aberrant user input;
circuitry for detecting the at least one aberrant user input at least partially in response to the at least one criterion; and
circuitry for presenting an anthropomorphic response at least partially in response to the at least one aberrant user input.

55. A system related to user input comprising:
means for providing at least one criterion for at least one aberrant user input;
means for detecting the at least one aberrant user input at least partially in response to the at least one criterion; and
means for presenting an anthropomorphic response at least partially in response to the at least one aberrant user input.

56. A system including but not limited to a program product, said program product comprising:
a signal bearing medium bearing one or more instructions for providing at least one criterion for at least one aberrant user input;
one or more instructions for detecting the at least one aberrant user input at least partially in response to the at least one criterion; and
one or more instructions for presenting an anthropomorphic response at least partially in response to the at least one aberrant user input.

57. (CANCELLED)

58. (CANCELLED)

59. The program product of claim 56, wherein the one or more instructions for providing at least one criterion for at least one aberrant user input further comprises:
one or more instructions for providing a criterion for an aberrant mechanical input.

60. The program product of claim 59, wherein the one or more instructions for providing a criterion for an aberrant mechanical input further comprises:
one or more instructions for providing a criterion for an aberrant intensity mechanical input.

61. The program product of claim 59, wherein the one or more instructions for providing a criterion for an aberrant mechanical input further comprises:
one or more instructions for providing a criterion for an aberrant frequency mechanical input.

62. (CANCELLED)

63. (CANCELLED)

64. The program product of claim 56, wherein the one or more instructions for providing at least one criterion for at least one aberrant user input further comprises:
one or more instructions for providing a criterion for an aberrant sonic input.

65. The program product of claim 64, wherein the one or more instructions for providing a criterion for an aberrant sonic input further comprises:
one or more instructions for providing a criterion for an aberrant intensity sonic input.

66. (CANCELLED)

67. (CANCELLED)

68. (CANCELLED)

69. The program product of claim 64, wherein the one or more instructions for providing a criterion for an aberrant sonic input further comprises:
one or more instructions for providing a criterion for an aberrant content sonic input.

70. The program product of claim 56, wherein the one or more instructions for detecting the at least one aberrant user input at least partially in response to the at least one criterion comprises:
one or more instructions for detecting an aberrant contact with a surface of a device.

71. The program product of claim 56, wherein the one or more instructions for detecting the at least one aberrant user input at least partially in response to the at least one criterion comprises:
one or more instructions for detecting an aberrant contact with an input device.

72. The program product of claim 56, wherein the one or more instructions for detecting the at least one aberrant user input at least partially in response to the at least one criterion comprises:
one or more instructions for detecting an aberrant moving of a device.

73. The program product of claim 56, wherein the one or more instructions for detecting the at least one aberrant user input at least partially in response to the at least one criterion comprises:
one or more instructions for detecting an aberrant shaking of a device.

74. (CANCELLED)

75. The program product of claim 56, wherein the one or more instructions for detecting the at least one aberrant user input at least partially in response to the at least one criterion comprises:
one or more instructions for detecting an aberrant throwing of a device.

76. The program product of claim 56, wherein the one or more instructions for detecting the at least one aberrant user input at least partially in response to the at least one criterion comprises:
one or more instructions for detecting an aberrant impact of a device.

77. The program product of claim 56, wherein the one or more instructions for detecting the at least one aberrant user input at least partially in response to the at least one criterion comprises:
one or more instructions for detecting an aberrant moving of an item operably coupled to the device.

78. The program product of claim 56, wherein the one or more instructions for detecting the at least one aberrant user input at least partially in response to the at least one criterion comprises:
one or more instructions for detecting an aberrantly repeated use of a mechanical input device.

79. The program product of claim 56, wherein the one or more instructions for detecting the at least one aberrant user input at least partially in response to the at least one criterion comprises:
one or more instructions for detecting an aberrant pressure exerted on a mechanical input device.

80. The program product of claim 56, wherein the one or more instructions for detecting the at least one aberrant user input at least partially in response to the at least one criterion comprises:
one or more instructions for detecting an aberrant sequential combination of inputs.

81. The program product of claim 56, wherein the one or more instructions for detecting the at least one aberrant user input at least partially in response to the at least one criterion comprises:
one or more instructions for detecting an aberrant simultaneous combination of inputs.

82. The program product of claim 56, wherein the one or more instructions for detecting the at least one aberrant user input at least partially in response to the at least one criterion comprises:
one or more instructions for detecting an aberrant combination of inputs within a pre-specified period of time.

83. The program product of claim 56, wherein the one or more instructions for detecting the at least one aberrant user input at least partially in response to the at least one criterion comprises:
one or more instructions for detecting an aberrantly repeated use of an access door.

84. (CANCELLED)

85. The program product of claim 56, wherein the one or more instructions for detecting the at least one aberrant user input at least partially in response to the at least one criterion comprises:
one or more instructions for detecting an aberrantly repeated removal of an item from the device.

86. The program product of claim 56, wherein the one or more instructions for detecting the at least one aberrant user input at least partially in response to the at least one criterion comprises:
one or more instructions for detecting an aberrantly repeated insertion of an item into the device.

87. (CANCELLED)

88. (CANCELLED)

89. (CANCELLED)

90. (CANCELLED)

91. (CANCELLED)

92. (CANCELLED)

93. (CANCELLED)

94. (CANCELLED)

95. (CANCELLED)

96. The program product of claim 56, wherein the one or more instructions for detecting the at least one aberrant user input at least partially in response to the at least one criterion comprises:
one or more instructions for detecting an aberrant exerting of pressure on a surface.

97. (CANCELLED)

98. (CANCELLED)

99. (CANCELLED)

100. The program product of claim 56, wherein the one or more instructions for presenting an anthropomorphic response at least partially in response to the at least one aberrant user input further comprises:
one or more instructions for presenting a response indicating a role subservient to a user of the device.

101. The program product of claim 56, wherein the one or more instructions for presenting an anthropomorphic response at least partially in response to the at least one aberrant user input further comprises:
one or more instructions for presenting a response imitating a human crying.

102. The program product of claim 56, wherein the one or more instructions for presenting an anthropomorphic response at least partially in response to the at least one aberrant user input further comprises:
one or more instructions for presenting a response imitating a human begging for mercy.

103. The program product of claim 56, wherein the one or more instructions for presenting an anthropomorphic response at least partially in response to the at least one aberrant user input further comprises:
one or more instructions for presenting a response imitating a human begging for forgiveness.

104. The program product of claim 56, wherein the one or more instructions for presenting an anthropomorphic response at least partially in response to the at least one aberrant user input further comprises:
one or more instructions for presenting a response imitating a human apologizing.

105. The program product of claim 56, wherein the one or more instructions for presenting an anthropomorphic response at least partially in response to the at least one aberrant user input further comprises:
one or more instructions for presenting a response imitating a human reacting to an infliction of pain.

106. The program product of claim 56, wherein the one or more instructions for presenting an anthropomorphic response at least partially in response to the at least one aberrant user input further comprises:
one or more instructions for presenting a response imitating a human expressing sarcasm.

107. The program product of claim 56, wherein the one or more instructions for presenting an anthropomorphic response at least partially in response to the at least one aberrant user input further comprises:
one or more instructions for presenting a response imitating a human expressing stoicism.

108. The program product of claim 56, wherein the one or more instructions for presenting an anthropomorphic response at least partially in response to the at least one aberrant user input further comprises:
one or more instructions for presenting a response imitating a human expressing humor.

109. The program product of claim 56, wherein the one or more instructions for presenting an anthropomorphic response at least partially in response to the at least one aberrant user input further comprises:
one or more instructions for presenting a response imitating a human expressing hostility.

110. The program product of claim 56, wherein the one or more instructions for presenting an anthropomorphic response at least partially in response to the at least one aberrant user input further comprises:
one or more instructions for presenting a response imitating a human expressing protest.
